(19) United States
(12) Patent Application Publication
(10) Pub. No.: US 2006/0238602 A1
(43) Pub. Date: Oct. 26, 2006

(54) Imaging method and apparatus for imaging a printing plate

(75) Inventor: Jorg-Achim Fischer, Laboe (DE)

Correspondence Address: LERNER GREENBERG STEMER LLP, P O BOX 2480, HOLLYWOOD, FL, 33022-2480, US

(73) Assignee: Heidelberger Druckmaschinen Aktiengesellschaft

(21) Appl. No.: 11/411,588

(22) Filed: Apr. 26, 2006

(30) Foreign Application Priority Data
Apr. 26, 2005 (DE) 10 2005 019 308.0

(51) Int. Cl. B41J 2/435

(52) U.S. Cl. 347/224

(57) ABSTRACT

A laser is used for digitally imaging a printing plate. Conventional UV printing plates, as are used in mask film imaging, are generally not suited for computer-to-plate (CTP) imaging methods. Here, the imaging method and the corresponding imaging apparatus permit the use of the conventional and more beneficial UV plates in a CTP imaging method and apparatus, in that the laser used is a quasi continuous wave laser (QCW laser), which emits laser pulses of a wavelength in the UV range.

### BACKGROUND OF THE INVENTION

### Field of the Invention

The present invention relates to an imaging method and an imaging apparatus for the digital imaging of a printing plate by using at least one laser.

In particular, the invention relates to computer-to-plate offset imaging methods (CTP) and corresponding apparatuses.

There are various alternative possible ways of imaging a printing form, in particular an offset printing plate. First of all, the printing plate can be imaged via an exposed film. In that case, depending on the type of plate, regions of the printing plate that are not to be exposed are covered by the film. This combination comprising printing plate and film is then acted upon with light of a specific wavelength by means of a specific exposure apparatus, so that the film is exposed in the regions which are not covered. For that purpose, the printing plate has a surface layer which is particularly sensitive to the wavelength or the wavelength range of the light used. In a further process step, the printing plate exposed in this way is developed further, possibly cleaned, and can then be used in a printing process. Frequently, in that type of exposure and imaging of the printing plate, UV light (ultra-violet) is used and the printing plates have a surface layer for the purpose which is particularly sensitive to UV radiation.

Over the course of time, further imaging methods for printing plates have also been developed. In the so-called computer to plate method (CTP), the printing plate is exposed directly without the creation of a specific film or mask film being needed. For this purpose, the printing plate is exposed, for example by means of a laser, it being possible for a bitmap to be used as a digital original. The printing image on the printing plate is built up pixel by pixel by means of the laser. The printing plate itself in this method again has a surface layer which is specifically sensitive to the wavelengths of the laser used.

The lasers that are employed are, for example, green lasers, infrared lasers, or violet lasers. For this purpose, there exist appropriate laser diodes with continuous laser signals, which are deflected onto the surface of the printing plate as a function of video signals which are obtained from the available bitmap. To this end, the laser beam is deflected pixel by pixel, that is to say point by point, by an optical modulator as a function of the video signals. A plurality of pixels or exposure points form a raster cell (screen cell), wherein they simulate a screen dot, the tonal value which is produced by the screen dot being determined by the number of exposure points exposed, the type of modulation used in the screening deciding on the precise arrangement of the pixels in a raster cell.

Depending on the design of the CTP exposer that is used, the laser beam is deflected onto a rotatable optical element; this is, for example, a deflection prism. The laser signals are then deflected onto the printing form as a function of the video signals. The deflection prism scans the entire surface of the printing form by experiencing a forward movement. For this purpose, it is disposed within an imaging cylinder and axially displaced along the axis of the imaging cylinder. That system is referred to as an in-drum exposer.

Other imaging methods can provide for the optical element for deflecting the laser to be located radially at a distance above an imaging cylinder and for the printing plate to rotate under this optical element. In this case, it is not necessary for a rotatable optical element to be used. The cylinder on which the printing plate is clamped rotates away under the optical element. That system is referred to as an ex-drum exposer. In particular, provision can also be made here for the laser or a large number of laser diodes to image the printing form. This can in particular be carried out directly.

A further imaging method is used in the case of flatbed scanners. There, the surface of a printing form is exposed by a laser or by an optical element which deflects the laser signal onto the surface of the printing form. The printing form and the lasers or the optical deflection apparatus are displaced laterally with respect to each other. Only if the use of a laser is omitted, as described in German published patent application DE 195 45 821 A1 (cf. U.S. Pat. No. 6,074,065) and, instead, the printing form is exposed via micro mirrors by way of a UV lamp, for example a metal halide lamp, is it possible to use a conventional UV printing plate.

None of the laser-driven CTP imaging methods described in the art allow the use of a conventional UV printing plates, as are used in the imaging methods with mask films described above. Instead, more expensive printing plates have to be used, which react sensitively to the corresponding wavelengths of the lasers. This also becomes clear, for example, from the article “Von Licht und Wärme” [Of Light and Heat], Druckmarkt Schweiz, Vol. 2-2001, pp. 24-26.

UV plates cannot be used in a cost-saving manner in CTP exposers having lasers, since correspondingly necessary UV lasers are not available in a beneficial and inexpensive diode design.

### SUMMARY OF THE INVENTION

It is accordingly an object of the invention to provide a method and an apparatus for imaging a printing plate which overcomes the above-mentioned disadvantages of the heretofore-known devices and methods of this general type and which makes it possible to use the conventional and more beneficial UV plates in a cost-effective manner in a CTP imaging method and a CTP apparatus.

With the foregoing and other objects in view there is provided, in accordance with the invention, an imaging method for digitally imaging a printing plate, which comprises providing at least one quasi continuous wave (QCW) laser and emitting laser pulses of a wavelength in the UV (ultra-violet) range with the laser; and imaging the printing plate with the laser.

In other words, the objects of the invention are achieved by an imaging method and an imaging apparatus for the digital imaging of a printing plate by means of at least one laser, wherein the laser used is a quasi continuous wave laser (QCW laser), which emits laser pulses of a wavelength in the UV range.

A QCW laser emits laser pulses with a pulse duration in the neighborhood of 10 picoseconds and at a frequency in a range from 80 MHz to 120 MHz; higher frequencies are also possible. QCW lasers can be obtained relatively cheaply on the market, for example from the Light Wave Electronics company, Coherent or Spectra Physics. The wavelength of the laser light emitted can beneficially lie in the UV range around 366 nm; the conventional UV-sensitive printing plates are sensitive to light of this wavelength. They can therefore be imaged practically by means of this quasi CW laser. As emerges from the article “Quasi CW Solid-State Lasers Expand Their Reach (Photonics Spectra, December 2001, pp. 54-58)”, the direct exposure of printed circuit boards by means of such QCW lasers is already known. However, since this exposure is substantially less problematic than in the case of printing plates, since it is not necessary to pay attention to moirés or raster accuracy, this method cannot simply be transferred to UV-sensitive printing forms such as UV printing plates.

Since a QCW laser does not emit a continuous laser signal but discharges a laser pulse, even if a high-frequency laser pulse, it may be necessary for various processes within the exposer to be driven as a function of the pulse frequency of the QCW laser. For this purpose, the invention beneficially provides for the pulse frequency of the QCW laser to be used to generate a master clock signal. In terms of apparatus, furthermore, a generating device for the generation of a master clock signal from laser pulses of the QCW laser is provided for this purpose.

A master clock signal is to be understood to mean a regular clock signal in response to which various other regularly repeating method steps or drive signals can be triggered.

In order to generate electric master clock signals from the laser pulses, the invention beneficially provides for the laser pulses to be deflected onto a photo-optical converter. According to the invention, this photo-optical converter is to be comprised by the generating device. The photo-optical converter can be, for example, a photodiode.

A photo-optical converter has a specific time constant. The time resolution of the photo-optical converter corresponds to this time constant. Depending on the photo-optical converter used, these time constants can vary but there exists a technically possible minimum which currently lies at around 20 picoseconds. A laser pulse from the QCW laser lies in the range of about 10 picoseconds. The position of the laser pulse in time can therefore not be registered directly by the photo-optical converter.

In order to be able to determine the position in time of the laser pulse more accurately, the invention provides for the generating device to have at least one optically active element which, on the basis of a laser pulse from the QCW laser, generates a light signal with a longer pulse duration for the purpose of registration by the photo-optical converter. By means of this optically active element according to the invention, a light signal having a longer pulse duration can be generated from at least one laser pulse. This light signal having the longer pulse duration can then be resolved and detected more accurately in time by the photo-optical converter. In this case, the pulse duration should lie at least in the region of the time constant of the photo-optical converter. This method step is not restricted to the pulse durations and time constants described but, in general, can be used when the pulse duration is shorter than the time constant, that is to say the measuring window of the photo-optical converter.

Advantageously, the invention can provide for the optically active element to comprise at least one optical medium that is excited to fluoresce by a laser pulse. This can be excited by the laser pulse to emit a light signal. Beneficially, optically active elements and fluorescent media can be used for this purpose which emit light signals which are longer than the pulse duration of the laser and, particularly advantageously, are longer than the time constant of the photo-optical converter. The photo-optical converter can use the fluorescence signal, which has the same frequency as the laser signal, to generate a master clock signal which corresponds to the frequency of the laser pulse. This is possible in particular as a result of the fact that the time interval between two laser pulses is considerably more than the pulse duration of a laser pulse or the duration of a fluorescence signal.

In an alternative embodiment, provision is made for the optically active element to comprise at least one optical medium that can be excited by the laser pulse to emit scattered light. This optical medium can be, for example, an optical fiber. This optical fiber can be positioned in such a way that the laser pulse passes through it axially and excites it to emit scattered light over its length. This scattered light is then emitted radially from the optical medium. The length of this optical medium determines the duration of the resultant light signal; it can first be collected and passed on or deflected directly onto the photo-optical converter. For example, an optical element or optical medium having a length of 6 mm should generate a light signal with a duration of about 20 picoseconds.

In a further alternative embodiment, provision is made for the optically active element to comprise at least one dispersive optical medium, which broadens the laser pulse in time. Within a dispersive optical medium, components of the laser pulse with a different frequency exhibit a different speed. They therefore traverse this medium at different times, which means that the resultant laser pulse is broadened in time. It can then be detected better by the photo-optical converter, in particular if its width in time is longer than the time constant of the photo-optical converter.

In a further development according to the invention and a corresponding alternative apparatus, provision is made for the optically active element to comprise at least one dispersive optical medium and an optical filter for high-frequency constituents of the laser pulse. It is then possible for high-frequency components to be filtered out of the broadened laser pulse and for the remaining parts of the laser pulse to be superimposed again. In this way, too, a light signal with a longer time is generated from the laser pulse. This can accordingly be detected by the photo-optical converter. In this way, the photo-optical converter is able to generate electronic signals which are available as a master clock signal in order to synchronize the sequences within the imaging apparatus with the pulse frequency of the QCW laser.

When using a QCW laser for imaging a printing form, in particular a printing plate, it is a problem that the pulse frequency of the QCW laser and the frequency of the video signals are substantially of the same order of magnitude, that is to say lie around 100 megahertz. In this way, it is possible for moirés, floating effects to occur as a result of the slightly different frequencies of the video signals and the laser pulses. According to the invention, provision is therefore made for the laser pulses to be deflected by an optical modulator as a function of video signals for imaging the printing form, the modulation frequency of the optical modulator being synchronized with the master clock signal. If the frequencies of the video signals and of the laser pulses are coordinated with one another in this way, it is ensured that one pixel corresponds to one laser pulse. Moirés then beneficially no longer occur.

The optical modulator is driven by the video signals. When driving the optical modulator, a drive delay occurs. In order to avoid exposure defects arising from the drive delay of the optical modulator, the invention provides for the drive delay to be taken into account when synchronizing the frequency of the optical modulator and the video signals with the pulse frequency of the quasi CW laser.

By driving the optical modulator by means of a video signal, a time window, a modulation window of the optical modulator, is opened. Within this time, the laser pulse corresponding to a video signal can be deflected or remain unaffected. It is necessary here to take account of the fact that, as a result of the scanning, time-dependent flanks of the drive of the modulator within the modulation window occur. Ideally, therefore, a laser pulse should traverse the modulator in the middle of a modulation window. In order to generate correct deflection of the laser pulse, the invention therefore provides for the width in time of the modulation window of the optical modulator to be taken into account for the synchronization.

In order to take into account the drive delay and/or the time width of the modulation window of the optical modulator, the invention beneficially provides that either the drive delay of the optical modulator or both the setting delay and the time interval between a laser pulse and the middle of the modulation window of the optical modulator are detected. If the sum of these two time intervals is known, the control of the video signals can be adapted appropriately, so that pixel-accurate driving of the optical modulator can be carried out.

According to the invention, provision is made for the time difference between the driving of the optical modulator and of a deflected laser pulse to be detected for this purpose.

In an alternative embodiment, the invention provides that, in order to detect this time difference, a second laser, which emits an auxiliary beam, is used. This auxiliary beam can be in particular a continuous laser beam which has a wavelength which differs from the wavelength of the laser pulse. In this case, the auxiliary beam and the laser pulse should be deflected substantially parallel to each other by the same optical modulators. In the further course, a filter can be incorporated which, for example, allows only laser signals above or below a predefined wavelength to pass, so that only laser pulses from the QCW laser can pass. This second laser can be used on its own for the purpose of detecting the drive delay and the relative position of a drive signal from the AOM in relation to the width of the modulation window.

In a further development of the invention, provision is advantageously made for a rotatable optical element to be used to deflect the laser pulses onto the printing form, the rotational frequency of the optical element being synchronized with the master clock signal. The rotational frequency of this optical element should in this case be an integer divisor of the frequency of the master clock signal. In this way, floating effects (moirés) are avoided as a result.

According to the invention, in a particular embodiment of the invention, provision is made for the rotatable element used to be a rotational prism. By means of the combination of the use of a QCW laser in the UV range and a rotational prism, it is possible to increase the rotational speed of the optical element and therefore to reduce the imaging duration. The reason for this is that the spot size of a UV laser is smaller than the spot size of the previously used lasers in the violet range or in other previously used wavelength ranges. As a result of this reduced spot size, it is possible to use a rotational prism with a smaller extent, which has a lower air resistance, which makes a higher rotational speed possible. A further advantage in the use of a rotational prism lies in the fact that the resolution of the printed image can alternatively be increased by the reduced spot size.

Other features which are considered as characteristic for the invention are set forth in the appended claims.

Although the invention is illustrated and described herein as embodied in an imaging method and apparatus for imaging a printing plate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagram showing the structure of a conventional drum exposer;

FIG. 2 is a raster cell having printing dots;

FIG. 3 shows a video signal belonging to the raster cell;

FIG. 4 shows a sequence of laser pulses from a quasi continuous wave (QCW) laser;

FIG. 5 is a diagram showing the structure of an internal drum exposer using a quasi CW laser;

FIG. 6A shows a possible structure of a master clock generating device;

FIG. 6B shows an alternative structure of a master clock generating device;

FIG. 6C shows a further alternative structure of a master clock generating device;

FIG. 6D shows a further alternative structure of a master clock generating device;

FIG. 7 is a diagrammatic view of a detail from a plate exposer having elements for the synchronization of the optical modulator; and

FIG. 8 is a diagrammatic view of an alternative structure of an apparatus for the synchronization of the optical modulator.

### DESCRIPTION OF THE PREFERRED EMBODIMENTS

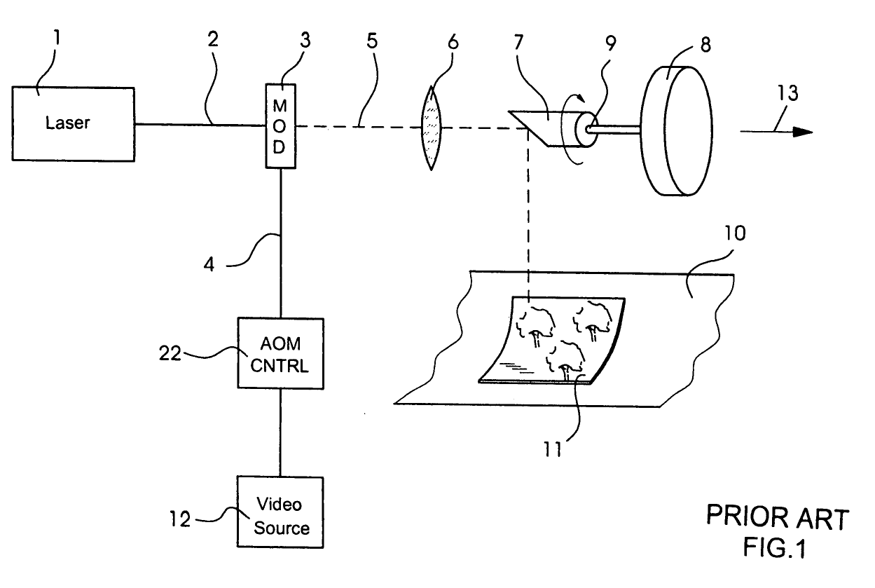

Referring now to the figures of the drawing in detail and first, particularly, to FIG. 1 thereof, there is seen the structure of an internal drum plate exposer according to the prior art. This is a conventional structure. Use is made of a laser source 1 which, in the case illustrated here, comprises a continuous wave laser. The laser source 1 emits a laser signal 2, which is transmitted through an acousto-optical modulator (AOM) 3, which modulates the laser signal 2 as a function of a video signal 4. A modulated laser signal 5 emerges from the acousto-optical modulator. By means of a lens 6, the modulated laser signal 5 is focused onto a specific location of a printing plate 11 via a rotational prism 7 and as a function of the video signal 4 and the lateral position of the rotational prism 7. The printing plate 11 is in this case clamped in the internal drum 10 of the printing plate exposer. The rotational prism 7 is driven in rotation about an axis of rotation 9 by a prism drive 8. The printing plate 11 is exposed line by line by way of the modulated laser signal 5 as a result of the rotation of the rotational prism 7. A non-illustrated forward movement device moves the rotational prism 7 in a forward movement direction 13. In this way—i.e., the relative movement between the plate 11 and the prism 7—the entire region of the printing plate 1 to be exposed can be exposed.

The video signal 4 is transferred by an AOM controller 22 to the acousto-optical modulator (AOM) and in this case consists of a pulse train as illustrated in FIG. 3. The AOM controller receives the video data belonging to the video signals from a video data source 12.

In order to image the printing plate 11, the rotational prism 7 is set rotating and, at the same time, moved in the forward movement direction 13. The laser beam 2 is modulated by the AOM 3 as a function of the exact position of the rotational prism 7 and the associated video data from the video data source 12. In this way, printing points 15 on the surface of the printing plate 11 are exposed. Depending on the printing plate used, the exposed printing points 15 are points which, following subsequent development of the printing plate 11, can accept ink or act in an ink-repellent manner. The individual printing points 15 are generated in this case from a printing original by way of a raster image processor (RIP). The latter is not shown here, for reasons of simplicity.

The rotational prism 7 has a rotational frequency of approximately 1 kHz. This corresponds approximately to a beam speed of 1000 m per second on the surface of the printing plate 11. A printing point 15, or image dot 15, should have a resolution of approximately 10 μm. This corresponds to a time length of 10 ns for the appropriately time-modulated laser signal 5. From this modulation window of the acousto-optical modulator AOM, this results in a modulation frequency of the AOM of 100 MHz. If the laser source 1 used is a CW laser, it is sufficient to synchronize the modulation frequency of the AOM with the rotational frequency of the rotational prism 7. In this case, the laser beam 2 has a constant intensity.

If the laser source 2 used is a quasi CW laser (QCW), however, then both the AOM 3 and the rotational prism 7 must be synchronized with the repetition rate, that is to say the pulse rate, of the laser source 1. This is not possible with the structure shown here. It proves to be particularly problematic that the modulation frequency of the AOM 3 at its 100 MHz lies in the region which corresponds to the pulse frequency of the laser. Slight timing differences between the driving of the AOM 3 and the pulse frequency of the laser source 1 then lead to moirés or artifacts in the resultant printed image. The same is also true of time differences between the repetition rate of the laser 1 and the rotational frequency of the rotational prism 7.

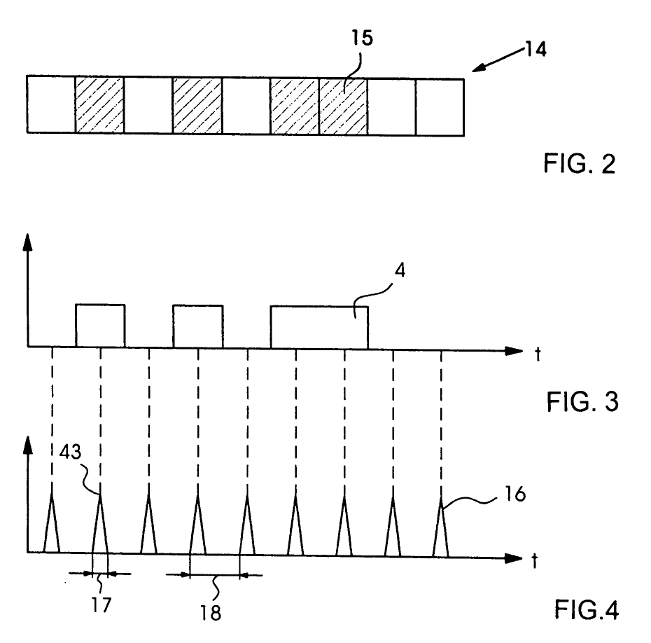

FIG. 2 shows a raster cell 14 comprising individual printing points 15, as are imaged on the printing plate 11 as a function of the video signals 4. Individual printing points 15 image pixels, or image dots, not illustrated here, on the printing plate 11. The width of a printing point 15 is in this case 10 μm.

FIG. 3 illustrates the variation over time of the pulses of a video signal 4, which modulate the acousto-optical modulator 3 in such a way that the printing points 15 illustrated in FIG. 2 are imaged on the printing plate 11. In the example shown here, the frequency of the video signal 4 is 100 MHz. This corresponds to a modulation window of the AOM 3 of 10 ns.

FIG. 4 shows the variation over time of the laser pulses 16 from a QCW laser of the laser source 1. The variation over time is shown here in such a way that it can be assigned to the pulses of the video signal 4 from FIG. 3. The phase angle of the laser pulses 16 is chosen such that the maximum values of the laser pulses 16 in each case fall in the middle of the modulation windows of the video signals 4.

The frequency of the laser pulses 16 is 100 MHz here, corresponding to the frequency of the video signals 4. The time interval 18 between two laser pulses 16 is therefore 10 ns. The width 17 of a laser pulse 16 is 10 μs.

FIGS. 2, 3, and 4 are arranged in vertical alignment so that it is possible to see the way wherein the laser pulses 16 interact with the video signals 4 in order ultimately to produce printing points 15 of a raster cell on a printing plate 11. If the frequency of the video signals differs from the frequency of the laser pulses 16, then the position of the pulses of the video signal 4 is displaced relative to the maximum values 43 of the laser pulses 16. In this way, moirés can arise in a printing image on the printing plate 11.

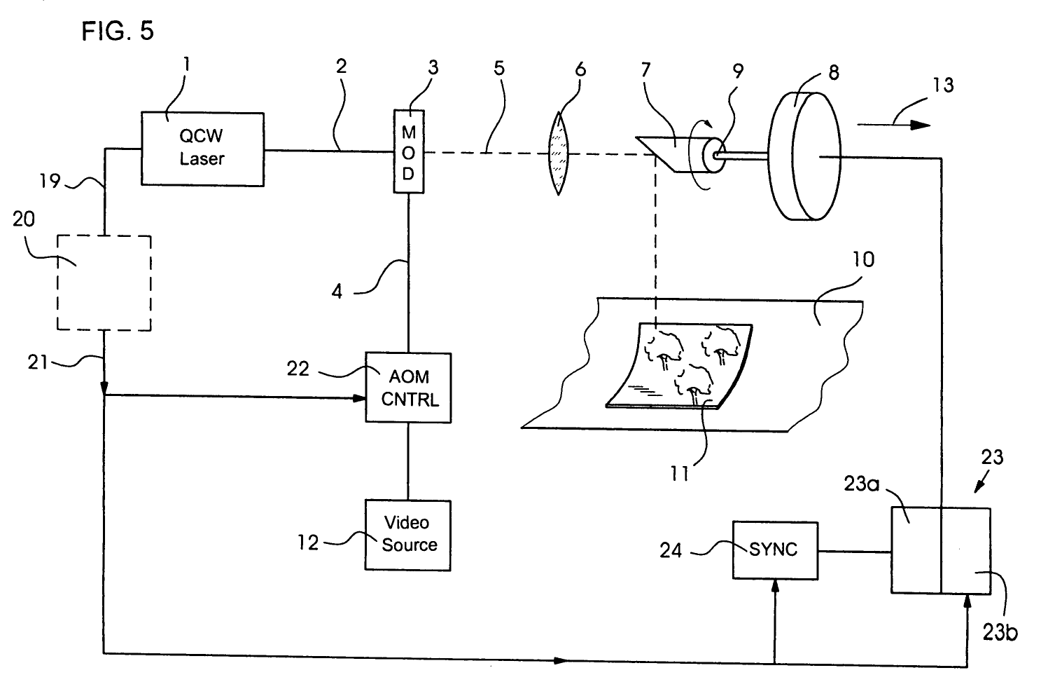

The structure of an in-drum exposer, wherein a QCW laser is used, is sketched in FIG. 5. Identical reference numbers here designate the same elements as in the preceding figures.

As distinct from FIG. 1, the laser source 1 used here is a QCW laser. The structure of the internal drum exposer is therefore wherein by additional elements and apparatuses which, in an inventive way, make the QCW laser usable for imaging the printing plate 11.

As already outlined in relation to FIG. 1, the laser source 1 emits a laser beam or a laser signal 2, which is modulated by an AOM 3 as a function of the video signal 4 and then is deflected accordingly by a rotational prism onto the printing plate 11 within the internal drum exposer. In order to make the QCW laser usable, provision is made here for the rotational prism 7 to be controlled as a function of the frequency of the laser source 1. For this purpose, a prism controller 23, which drives the rotational prism 7, is provided. To this end, the prism controller 23 firstly has a rotation controller 23a, which controls the rotational frequency of the rotational prism 7. Secondly, the prism controller 23 has a forward movement controller 23b, which drives the forward movement speed of the rotational prism in a forward movement direction 13. The rotation controller 23a is in turn matched to the clock rate of the laser source 1 by a rotation synchronizer 24.

In order to synchronize the video signal 4 with the laser pulses 16 of the laser source 1, provision is made for the AOM controller 22 to be matched appropriately to the frequency of the laser source 1.

The forward movement controller 23b of the rotation synchronizer 24 and the AOM controller 22 are in each case matched to the frequency of the laser source 1 via a master clock signal 21. The master clock signal 21 is generated from a laser beam 19 from the laser source 1 via a master clock generating device 20. The AOM controller 22 is therefore synchronized with the master clock signals, by their phase angle being adapted appropriately. The frequency of the video signal 4 can therefore in particular coincide with the frequency of the laser pulses 16. In these ways, by means of synchronization or triggering of the video signal 4 as a function of the master clock signal 21, exact superimposition of the driving of the acousto-optical modulator 3 as a function of the laser pulses 16 can be achieved. In this way, a moiré can successfully be avoided.

Within the rotation synchronizer 24, the frequency of the master clock signal 21 is divided by a divisor, which is not illustrated here. The rotational frequency of the rotational prism 7 multiplied with the divisor is intended to result exactly in the frequency of the master clock signal 21. The divided frequency of the master clock signal should therefore correspond to the rotational frequency of the rotational prism 7. To this extent, the rotational frequency which results from the rotation controller 23a is compared with the divided master clock frequency in the rotation synchronizer 24. The rotation controller 23 will then automatically adapt the rotational frequency of the rotational prism 7 to such an extent that the rotational frequency corresponds to the divided master clock frequency and has an identical phase angle. In this way, it is possible to ensure that each position of the rotational prism 7 is assigned to a specific printing point on the printing plate 11. As a result of the matching or triggering of the rotational frequency of the rotational prism 7 to the master clock frequency 21, it is ensured that it is not possible for moirés to occur on account of slight mismatching of the corresponding frequencies.

Furthermore, provision is advantageously made for the forward movement speed in the forward movement direction 13 of the rotational prism 7 to be regulated as a function of the master clock frequency. All the constituent parts of the imaging of the printing plate 11 are therefore synchronized with the frequency of the master clock signal 21. In this way, exact imaging of the printing plate 11 can be carried out.

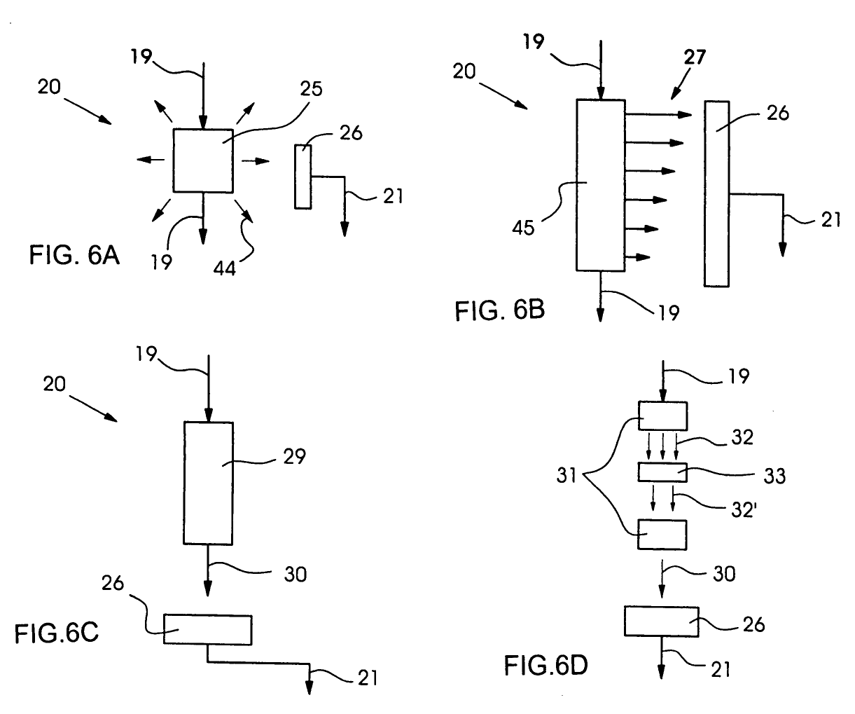

FIGS. 6A to 6D show various alternative embodiments of the structure of a master clock generating device.

As already outlined, the width 17 of a laser pulse 16 from the QCW laser is too small to generate a master clock signal 21 directly therefrom. The structures illustrated in FIGS. 6A to 6D are therefore used for the purpose of spreading out the time duration of the laser pulse 16 of the laser signal 19 to such an extent that the spread signal can be detected by a photodiode 26 and a master clock signal 21 can be generated directly by this photodiode 26.

The laser signal 19 can in this case be derived from the laser source 1. It is possible that the laser signal 19 is led out at a different point than the laser signal 2 in relation to the laser source 1. The two points can, however, also coincide in one point. In particular, optical elements can be present which split an emitted laser signal 2 into a laser signal 2 leading onward, which is used to image the printing plate 11, and a laser signal 19 which is used to generate the master clock signal 21.

In the alternative structures, the laser signal 19 passes through an optical element in each case, by which means a longer light signal is generated which has a time constant which lies at least in the range of the time constant of the photodiode 26. The photodiode 26 can in each case detect the light signal generated and convert it into a master clock signal 21. In this way, the master clock signal 21 has the same frequency as the laser signal 19 and has an identical, possibly displaced, phase angle.

In FIG. 6A, the optical element is a fluorescent optical medium 25. This medium 25 is excited by the laser signal 19 to emit light signals 44. In this case, the medium 25 is chosen such that the duration of the light signals 44 in each case exceeds the time constant of the photodiode. Light signals 44 then strike the photodiode 26 and generate the master clock signal 21 there.

In FIG. 6B, the laser signal 19 passes through a fiber 45. During this passage through the fiber 45, scattered light 27 is generated along the optical path of the laser signal 19 and is emitted at right angles to the direction of the laser signal 19. In this case, the length of the fiber 45 is somewhat more than 6 mm, so that the scattered light 27 falls onto a sufficiently large photodiode 26 over a sufficiently large time period. In this way, too, a corresponding master clock signal 21 is generated.

In FIG. 6C, the optical element is a stepped index fiber 29. Within the stepped index fiber 29, the laser signal 19 experiences dispersion. The laser pulse 16 is dispersed as a result, so that its width in time 17 changes accordingly. On the other side of the stepped index fiber 29, a correspondingly lengthened light pulse 30 then exits. The length of the stepped index fiber 29 is chosen such that the width in time of the light pulse 30 is greater than the time constant of the photodiode 26. In this way, a master clock signal 21 can be generated by the light pulses 30 striking the photodiode 26.

In FIG. 6D, the laser signal 19 is achieved by means of broadening the laser pulses 16 over time by means of dispersion and spectral filtering. The laser signal 19 first passes through a first prism 31, which splits the laser signal 19 into corresponding light signals 32. These light signals 32 then pass through an optical filter 33. This optical filter 33 then filters individual spectral components of the laser pulse 16 out of the laser signal 19. In this way, laser signals 32′ which emerge from the filter 33 are obtained. The light signals 32′ have a smaller spectral distribution than the light signals 32. They are then focused by a second prism 31 and result in a light pulse 30. Because of the smaller spectral width, this light pulse has a greater width in time than the signal 19. By means of suitable selection of the filters 33 or of the filter 33, it is possible to achieve the situation wherein the width of the light signals 30 is sufficient to generate a master clock signal 21 by means of the photodiode 26.

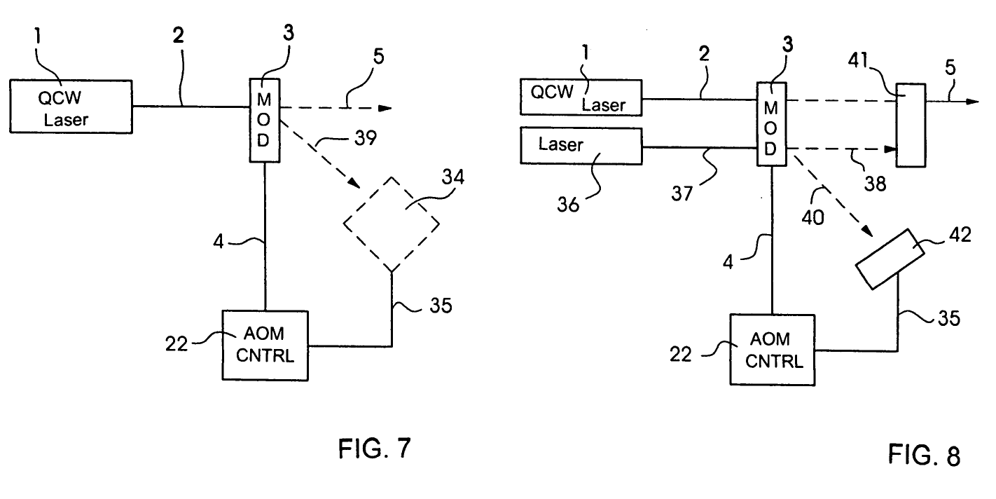

FIGS. 7 and 8 show different alternatives of structures having elements for the synchronization of the AOM 3. In each case, these are extracts from a corresponding plate exposer with QCW laser. These structures can in particular be provided in addition to the structures described for the synchronization of the video signal 4 and the rotational frequency and forward movement speed of the rotational prism 7, as have been described in FIG. 5.

In the structure sketched in FIG. 5, the laser signal 2 from the laser source 1 is modulated by a modulator AOM 3 in accordance with the video signal 4, so that a modulated laser signal 5 accordingly leaves the AOM 3. Here, the same reference numbers also signify the same elements as in the preceding figures.

The laser signal 2 is deflected by the modulator (AOM) 3. Depending on the video signal 4 present, the result is a modulated laser signal 5 or a second, deflected laser signal 39. In terms of its structure, this laser signal 39 corresponds to a complementary laser signal to the modulated laser signal 5. This laser signal 39 then enters a delay detection element 34. This delay detection element generates signals 35 from the laser signal 39. In terms of their frequency, these signals 35 correspond to the laser signals 39, and their phase angle is caused by the delay, that is to say the “inertia” of the AOM with respect to the video signal 4. The “inertia” of the AOM 3 is brought about here by propagation times of the signal in relation to the AOM 3, by the limited speed of sound within the AOM 3, by the spot size of the laser signal 33 and possibly further factors. Within the AOM controller 22, the phase angle of the video signal 4 for driving the AOM 3 can then be compared with the signals 35. In this way, the time offset between the driving of the AOM 3 via the video signal 4 and the deflection of the laser signal 2 into laser signals 39 actually carried out can be determined. This time offset, which has become known from the latter, can be used to drive the AOM 3 via the AOM controller 22, so that, in particular in conjunction with the comparison with the master clock signal 21, the pulses 16 from the laser signal 2 lie in the middle of the modulation window of the AOM 3. Corresponding correct driving of the AOM 3 was illustrated in FIGS. 2 to 4. Here, the maximum values 43 of the laser pulses 26 lie in the middle of the modulation window of the AOM 3. In this way, the entire laser pulse 16 can be used for imaging the printing plate 11 without the laser signal being distorted by rising or falling flanks of the modulation window of the AOM 3.

The delay detection element 34 is illustrated dashed here, since, in terms of structure, it is constructed in such a way that a measurable synchronized signal 35 can be generated from the short laser pulses 16. Its structure corresponds to that of the master clock generating device 20; in this regard, reference is made in particular to the possible alternative embodiments which have been described in FIGS. 6a to 6d.

A similar structure to that in FIG. 7 is shown in FIG. 8 but here, in order to determine the time offset, that is to say the delay of the AOM 3 as a function of the video signals 4, a second laser source 36 is used. This laser source 36 emits a continuous laser signal 37. In this case, this laser signal 37 can in particular have a wavelength which is different from the wavelength of the laser signal 2. For example, the laser signals 2 can have a wavelength of 355 nm while the wavelength of the laser signal 37 is 370 nm. The laser signal 37 is modulated in accordance with the video signal 4, so that a modulated laser signal 38 and a correspondingly complementary deflected laser signal 40 are generated. Since the deflected laser signal 40 is a laser signal which is modulated but still continuous, the duration of the individual signal pulses of the modulated deflected laser signal 40 corresponds to the length in time of the modulation windows of the AOM 3 and thus substantially to the duration of the video signals 4. The frequency of the deflected laser signal 40 is therefore at most 100 MHz in the example illustrated here. This corresponds to a shortest duration of a signal section of 10 ns of the deflected laser signal 40. Light pulses of this order of magnitude can be detected without difficulty by a photodiode 42. In this way, via the deflected laser signal 40, which falls onto a photodiode 42, a signal 35 can then be generated without difficulty. As described in relation to FIG. 7, this signal 35 can then be compared with the time waveforms of the video signal 4 within the AOM controller 22. A corresponding time offset can be detected and taken into account appropriately when driving the AOM 3. In order to avoid the laser signal 38 modulated by the AOM 3 being able to act in any way on the rotational prism 7 or on the 3-D imaging of the printing plate 11, provision can be made for a filter 41 to be provided in the beam path of the modulated laser beams 38 and 5. This optical filter is then designed in such a way that it filters out light of the wavelength of the laser signal 37 while allowing laser signals of the wavelength of the laser signal 2 through. In this way, the imaging of the printing plate 11 can readily be carried out.

Via the generation of the master clock signal 21, all the elements involved in the imaging of the printing plate 11 can be synchronized appropriately with the frequency of the laser signal 2. This includes, in particular, the rotational frequency of the rotational prism 7, the forward movement speed of the rotational prism 7 and the driving of the video signal 4 via the AOM controller 22. Via the additional detection of the delay of the AOM 3, as has been described in FIGS. 7 and 8, the time offset of the modulation window of the AOM 3 in relation to its actual driving can be detected and taken into account. In this way, moirés can be prevented in an ideal manner and the video signal 4 can drive the AOM 3 in such a way that the laser pulses 16 lie with their maximum values 23 in the middle of a modulation window of the AOM 3 in each case.

In this way, it can beneficially be made possible for quasi continuous wave lasers with a wavelength of 355 nm to be available for the imaging of printing plates 11. These quasi continuous wave lasers are substantially less expensive than conventional continuous UV lasers and can advantageously image the conventional UV-sensitive printing plates 11.

This application claims the priority, under 35 U.S.C. § 119, of German patent application No. 10 2005 019 308.0, filed Apr. 26, 2005; the entire disclosure of the prior application is herewith incorporated by reference.

I claim:

1. An imaging method for digitally imaging a printing plate, which comprises:
providing at least one quasi continuous wave (QCW) laser and emitting laser pulses of a wavelength in a UV range with the laser; and
imaging the printing plate with the laser.

2. The imaging method according to claim 1, which comprises using a pulse frequency of the QCW laser to generate a master clock signal.

3. The imaging method according to claim 2, which comprises generating the master clock signal by deflecting laser pulses onto a photo-optical converter.

4. The imaging method according to claim 3, which comprises generating a light signal from at least one laser pulse having a longer pulse duration than the at least one laser pulse.

5. The imaging method according to claim 4, which comprises exciting a fluorescent optical medium with the laser pulse to emit a light signal.

6. The imaging method according to claim 4, which comprises exciting an optical element along the propagation direction of the laser pulse to emit scattered light.

7. The imaging method according to claim 4, which comprises broadening the laser pulse.

8. The imaging method according to claim 7, which comprises filtering high-frequency components out of the broadened laser pulse and, after filtering, superimposing remaining parts of the laser pulse.

9. The imaging method according to claim 1, which comprises deflecting the laser pulses by an optical modulator as a function of video signals defining the imaging of the printing plate, generating a master clock signal, and synchronizing the modulation frequency of the optical modulator with the master clock signal.

10. The imaging method according to claim 9, which comprises taking into account a drive delay of the optical modulator in the synchronizing step.

11. The imaging method according to claim 9, which comprises taking into account a width in time of a modulation window of the optical modulator in the synchronizing step.

12. The imaging method according to claim 2, which comprises detetecting a drive delay of the optical modulator or detecting the drive delay and a time interval between a laser pulse and a middle of the modulation window of the optical modulator.

13. The imaging method according to claim 12, which comprises detecting a time difference between a driving of the optical modulator and of a deflected laser pulse.

14. The imaging method according to claim 13, wherein the step of detecting the time difference comprises using a second laser emitting an auxiliary beam.

15. The imaging method according to claim 1, which comprises deflecting the laser pulses onto the printing plate with a rotating optical element, generating a master clock signal, and synchronizing a rotational frequency of the optical element with the master clock signal.

16. The imaging method according to claim 15, wherein the rotating optical element is a rotational prism.

17. An imaging apparatus for digitally imaging a printing plate, comprising at least one quasi continuous wave (QCW) laser configured to emit laser pulses of a wavelength in a UV range for imaging the printing plate.

18. The imaging apparatus according to claim 17, which further comprises a generating device connected to said QCW laser for generating a master clock signal from laser pulses from said QCW laser.

19. The imaging apparatus according to claim 18, wherein said generating device includes at least one photo-optical converter.

20. The imaging apparatus according to claim 19, wherein said generating device has at least one optically active element configured to generate, on a basis of a laser pulse from said QCW laser, a light signal with a longer pulse duration for the purpose of registration by said photo-optical converter.

21. The imaging apparatus according to claim 20, wherein said optically active element comprises an optical medium configured to be excited to fluoresce by a laser pulse.

22. The imaging apparatus according to claim 20, wherein said optically active element comprises at least one optical medium configured to be excited by the laser pulse to emit scattered light.

23. The imaging apparatus according to claim 20, wherein said optically active element comprises at least one dispersive optical medium disposed to broaden the laser pulse in time.

24. The imaging apparatus according to claim 20, wherein said optically active element comprises at least one dispersive optical medium and an optical filter for high-frequency components of the laser pulse.
